(19) United States
(12) Patent Application Publication
(10) Pub. No.: US 2004/0149852 A1
(43) Pub. Date: Aug. 5, 2004

(54) Belt spool for a safety belt retractor

(75) Inventors: Herbert Blum, Schwabisch Gmund (DE); Hermann-Karl Weller, Alfdorf (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/754,754

(22) Filed: Jan. 9, 2004

(30) Foreign Application Priority Data
Jan. 31, 2003 (DE) 203 01 518.5

(51) Int. Cl. B60R 22/405

(52) U.S. Cl. 242/383.2; 242/384

(57) ABSTRACT

A belt spool (12) for a safety belt retractor with a frame has a bearing (18) for a blocking catch (16) which can be moved from an initial position in which the belt spool is freely rotatable, into a blocking position in which it blocks the belt spool. The belt spool further has a support surface (20) for the blocking catch (16). The support surface (20) is provided with a projection (22; 26).

### TECHNICAL FIELD

The invention relates to a belt spool for a safety belt retractor.

### BACKGROUND OF THE INVENTION

A conventional belt spool typically has a bearing for a blocking catch which can be moved from an initial position in which the belt spool is freely rotatable, into a blocking position in which it blocks the belt spool, and a support surface for the blocking catch.

The belt spool with the blocking catch arranged on it is rotatably mounted in a frame of the safety belt retractor. Provided on the frame is a blocking toothing, into which the blocking catch engages, when the latter is situated in its blocking position. For moving the blocking catch from the initial position into the blocking position, any desired release mechanism, known from prior art, can be used, which responds in a belt band-sensitive or vehicle-sensitive manner.

The invention is based on the problem of improving the mounting of the blocking catch on the belt spool.

### BRIEF SUMMARY OF THE INVENTION

According to the invention, a belt spool for a safety belt retractor with a frame has a bearing for a blocking catch which can be moved from an initial position in which the belt spool is freely rotatable, into a blocking position in which it blocks the belt spool. The belt spool further has a support surface for the blocking catch. The support surface is provided with a projection. This projection can serve two functions: Firstly, the projection can be constructed as a gentle curvature of the support surface, which is shaped such that the rotation point of the blocking catch shifts when it is moved from the initial position into the blocking position. This prevents a bent lever effect from occurring in the case of high loads, in which the belt spool slightly works itself into the frame, which effect makes difficult a return movement of the belt spool; therefore the return movement of the blocking catch from the blocking position into the initial position is only possible to a very poor extent. Secondly, the projection can be formed by a rib which can be plastically deformed and is designed such that it is already deformable by the blocking catch at comparatively low forces. This leads to the non-deformed section of the projection, lying immediately adjacent to the blocking catch, forming a contact surface acting in radial direction, which supports the blocking catch against displacements in radial direction. In this way, with minimum effort it can be prevented that the blocking catch slips laterally from the support surface. A contact surface effective in radial direction could basically also be constructed from the outset in the manufacture of the belt spool. As such a contact surface, however, represents an undercut, a complicated slider would have to be provided in the die casting tool used for the production of the belt spool. In addition, in the region of the contact surface, burrs would inevitably occur, which would have to be subsequently removed at a high expenditure.

### BRIEF DESCRIPTION OF THE DRAWINGS

FIG. 1 shows a belt spool with a blocking catch according to a first embodiment, the blocking catch being in the initial position;

FIG. 2 shows the belt spool of FIG. 1, the blocking catch being in the blocking position;

FIG. 3 shows a cutout of a belt spool according to a second embodiment;

FIG. 4 shows the belt spool of FIG. 3 in a perspective view, a blocking catch being shown which is in the initial position;

FIG. 5 shows the belt spool of FIG. 4, the blocking catch being in the blocking position; and

FIG. 6 shows diagrammatically a section along plane VI-VI of FIG. 5.

### DETAILED DESCRIPTION OF THE PREFERRED EMBODIMENTS

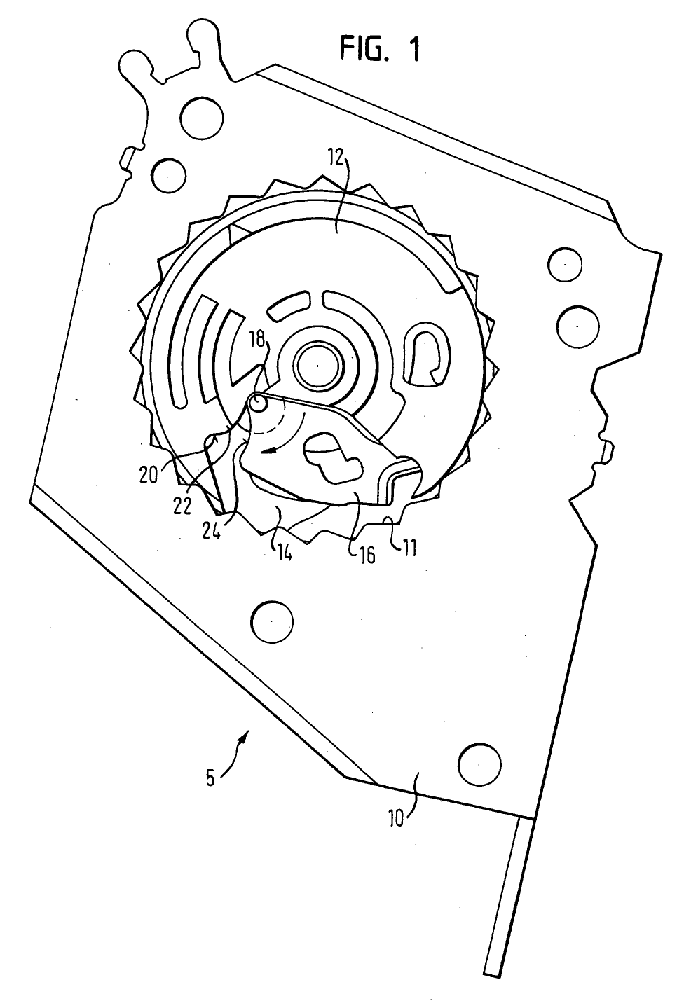

In FIG. 1, a belt retractor 5 is shown diagrammatically, which has as essential components a frame 10 and a belt spool 12. The frame is provided with an opening, on the edge of which a blocking toothing 11 is constructed.

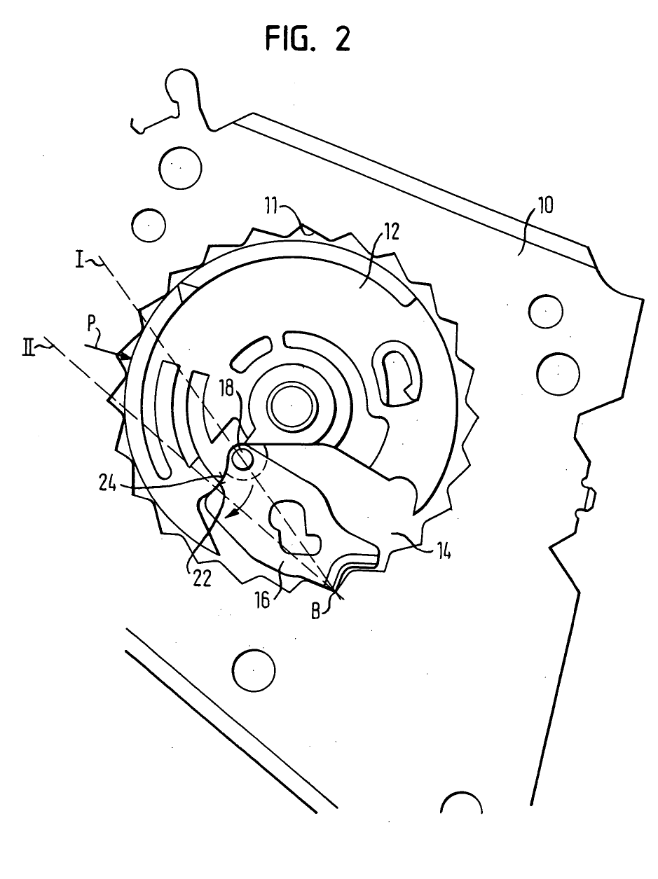

On the end face of the belt spool 12, to be seen in FIGS. 1 and 2, a pocket 14 is formed, in which a blocking catch 16 is arranged. The blocking catch can pivot from an initial position shown in FIG. 1, in which it is arranged in the pocket 14 and does not engage into the blocking toothing 11, into a blocking position shown in FIG. 2, in which it engages into the blocking toothing 11. This blocks the belt spool 12 against a rotation in an anticlockwise direction, which corresponds to a blocking against a belt band withdrawal. To swivel the blocking catch, any desired control mechanism can be used which is known from the prior art.

The blocking catch 16 has a bearing pin 18 which engages into a recess in the belt spool 12 and forms the bearing for the blocking catch 16, as long as the latter is in the initial position. In addition, on the edge of the pocket 14 a support surface 20 is constructed, which is provided with a gently curved projection 22. The blocking catch 16 is provided with a correspondingly curved counter-surface 24.

When the blocking catch is in its blocking position (see FIG. 2), the counter-surface 24 lies against the support surface 20. Owing to the projection 22, the bearing pin 18 has no further function, and a rotation point displacement occurs, because the blocking catch is now able to pivot about the projection 22, if only within certain limits. In FIG. 2, a line II is drawn, which passes through the rotation point of the blocking catch when the latter is in the blocking position, and through the contact point B between blocking catch and blocking toothing 11. A line I is placed through the rotation point of the blocking catch, which would be determined by the bearing pin 18, as is the case in the prior art with the blocking catch situated in the blocking position.

In FIG. 2 in addition, arrow P designates the region of the blocking toothing 11 in which the greatest abutment forces of the belt spool on the frame occur with high loads of the belt spool. As the belt spool works itself slightly into the frame in the case of high loads, it must rotate about this point P when it is turned back in the belt band winding direction after high loads, in order to return the blocking catch from the blocking position into the initial position again.

If the belt spool is now turned in the belt band winding direction, i.e. clockwise with respect to FIG. 2, the belt spool rotates about point P, so that the bearing point of the blocking catch moves downwards. With a construction according to prior art, in which the blocking catch rotates about the bearing pin 18, the two distances between point B and the bearing pin 18 on the one hand and the bearing pin 18 and point P on the other hand form a toggle-lever press; when the belt spool rotates about the point P, the bearing pin 18 must “push apart” in an imaginary manner the two points B and P. This leads either to high forces being necessary in order to turn the bearing pin 18 so far downwards, until it lies with the points P and B on a line and reaches the dead center of the toggle-lever press, or else to the belt spool jamming with the blocking catch, so that the blocking catch can no longer be returned into the initial position.

In the structure according to the invention, on the other hand, the rotation point of the blocking catch lies beneath the straight connecting line between the points B and P, so that the blocking catch, with a rotation in the belt band winding direction, is pulled out directly from the blocking toothing. A jamming is impossible.

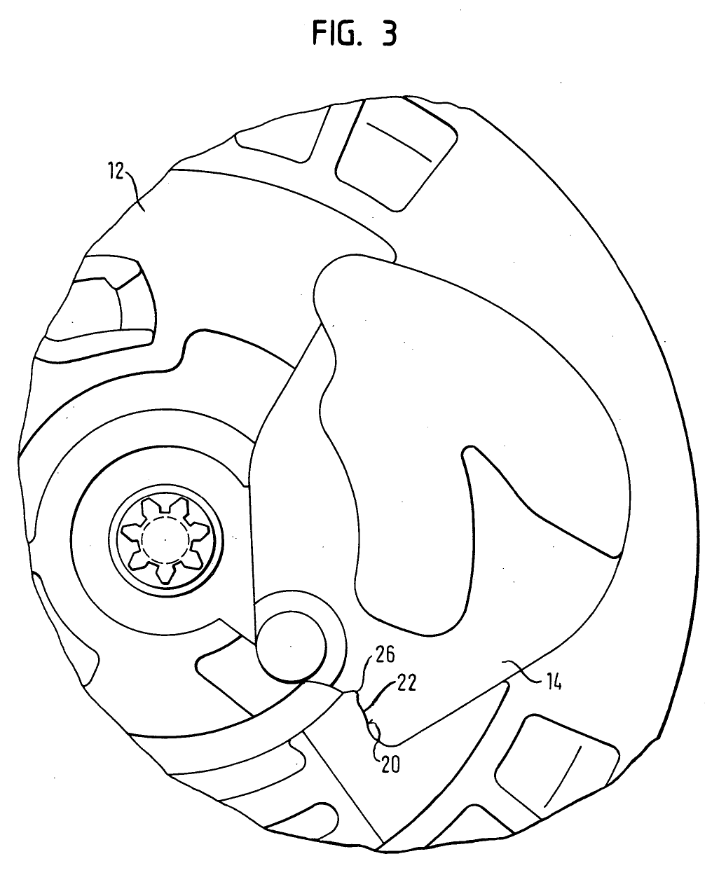

In FIGS. 3 to 6, a second embodiment is shown. The difference to the first embodiment consists in that on the support surface 20, more precisely approximately centrally on the projection 22, a rib 26 is arranged, which is aligned parallel to the rotation axis of the belt spool 12. The rib 26 can be plastically deformed, being designed such that it is already deformed by the blocking catch 16 at comparatively low forces. These forces lie considerably below those which act on the safety belt retractor in an accident. For example, the rib 26 can be designed such that it is plastically deformed by the blocking catch 16, more precisely it is pressed flat, at that forces which are exerted by the vehicle occupant onto the safety belt and hence onto the blocking catch with a hard braking of the vehicle.

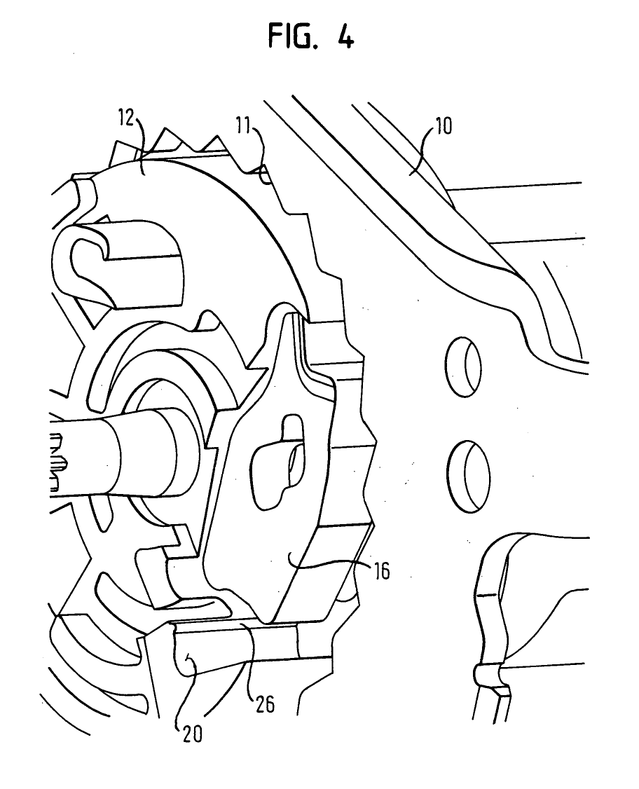

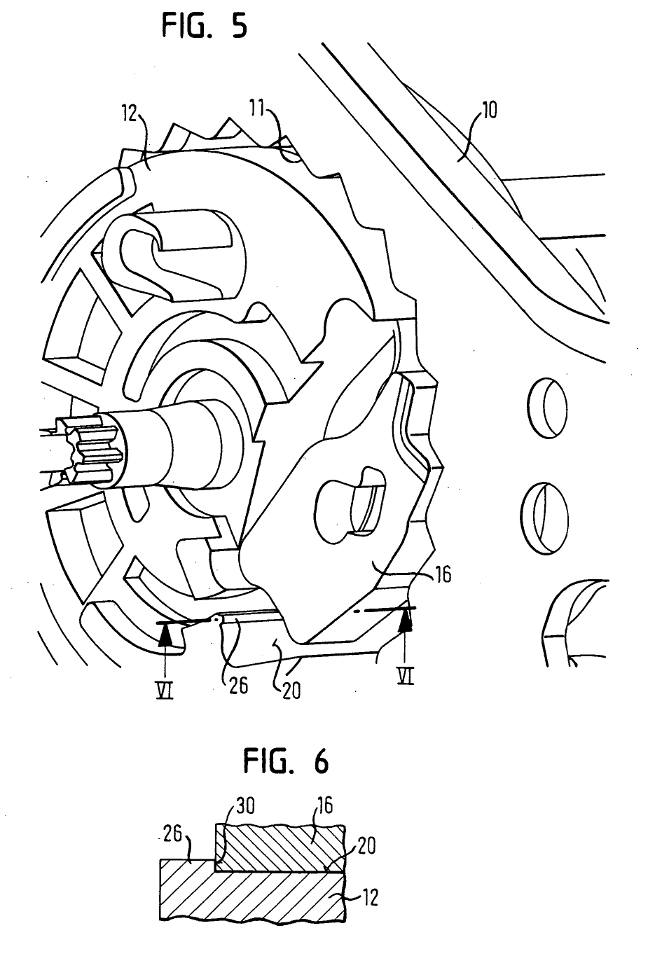

In FIGS. 3 and 4, the rib 26 is shown in the initial state, i.e. non-deformed. In FIGS. 5 and 6, the rib 26 is shown in the state when plastically deformed. As can be seen in particular in FIG. 6, a part of the rib 26 is pressed flat by the blocking catch 16, so that it no longer projects (or at least no longer noticeably) over the support surface 20. Thereby, immediately adjacent to the blocking catch 16 an abutment surface 30 is formed, namely by the region of the non-deformed rib 26 lying adjacent to the blocking catch 16. The abutment surface 30 prevents the blocking catch 16 from slipping in axial direction outwards on the support surface 20.

The particular advantage of the support surface 30 consists in that it does not already have to be produced during the casting of the belt spool, which in fact would lead to an undercut having to be produced by a slider. Instead of this, the belt spool can be cast without an undercut, and the abutment surface 30 is produced automatically with the first higher stressing of the belt retractor.

1. A belt spool (12) for a safety belt retractor with a frame, said belt spool comprising a bearing (18) for a blocking catch (16) which can be moved from an initial position in which said belt spool is freely rotatable, into a blocking position in which it blocks said belt spool, and a support surface (20) for said blocking catch (16), characterized in that said support surface (20) is provided with a projection (22; 26).

2. The belt spool according to claim 1, characterized in that said projection (22) is formed by a gentle curvature of said support surface (20).

3. The belt spool according to claim 2, characterized in that said curvature is constructed such that a rotation point of said blocking catch (16) shifts when it is moved from said initial position into said blocking position.

4. The belt spool according to claim 3, characterized in that said rotation point of said blocking catch (16), in relation to a direction of rotation of said belt spool in a belt band unwinding direction, lies behind a line which runs through a contact point between said blocking catch and a blocking toothing on said safety belt retractor and a support point of said belt spool on said frame of said safety belt retractor.

5. The belt spool according to claim 1, characterized in that said projection is formed by a rib (26) which can be plastically deformed.

6. The belt spool according to claim 5, characterized in that said rib (26) is designed such that it is already deformable by said blocking catch (16) at comparatively small forces.

7. The belt spool according to claim 5, characterized in that a non-deformed region of said rib (26) forms an abutment surface (30) for said blocking catch (16) which is effective in axial direction.
